(19) United States
(12) Patent Application Publication
(10) Pub. No.: US 2004/0029565 A1
(43) Pub. Date: Feb. 12, 2004

(54) Voice response unit, method thereof and telephone communication system

(76) Inventors: Junji Shibata, Tokyo (JP); Mats Akesson, Upplands Vasby (SE); Tetsuo Kamoshita, Saitama (JP)

Correspondence Address: ERICSSON INC., 6300 LEGACY DRIVE, M/S EVW2-C-2, PLANO, TX, 75024, US

(21) Appl. No.: 10/362,208

(22) PCT Filed: Aug. 29, 2001
(86) PCT No.: PCT/JP01/07412

(30) Foreign Application Priority Data
Aug. 29, 2000 (JP) 2000-259015

(51) Int. Cl. H04M 1/66; H04M 1/68; H04M 3/16

(52) U.S. Cl. 455/411; 455/410

(57) ABSTRACT

To provide a voice response unit for use with a telephone communication system, which is able to authenticate a user. Information-providing sites 8, 11 which provide a service using the voice response unit, has user databases 9, 12 for storing the information identifiable of a service subscriber. On the other hand, a voice response unit 5 is provided with a similar user DB 6. If a new subscription or cancellation arises for the service using the voice response unit 5 in the information-providing sites and contents of the user database 9 is changed, a database update instruction is transmitted to the voice response unit 5, so that contents of the user DB 6 is synchronized with contents of the user database 9 or 12. The voice response unit 5 makes authentication of the subscriber using the user DB 6, and provides voice information only to a valid subscriber.

### TECHNICAL FIELD

The present invention relates to a voice response unit and its control method, and more particularly to a voice response unit for use with a telephone communication system and capable of providing voice information through a telephone line, and its control method.

The invention relates to a telephone communication system which uses a voice response unit.

### BACKGROUND ART

A portable wireless telephone or PHS has been providing a variety of kinds of services other than the voice communication, as the portable telephone or PHS has spread. As a supplementary service other than the voice communication, there is a charged service for providing a voice or image of notables or popular characters. The voice or image provided in such service is usually charged, and a registration is necessary to make use of the service.

When the service is provided, the registered subscriber makes connection to a web site of the service provider, and designates the content of a desired service by selecting items on the menu from the web page. A web page displayed for this designated service or a mail transmitted to the registered subscriber in response to the designated service describes a connection number (telephone number) to the voice response unit assigned for providing the designated service (e.g., listening to the voice of a desired artist. And by calling its connection number, the subscriber is connected to the voice response unit to receive the desired service.

In the service of this kind, in order to permit only the registered subscriber to make use of the service, when there is a display request of the web page to use the service, or when the service designation is made, for example, the information unique to the subscriber, such as the subscriber's number, which was registered at the time of subscription to the service, is checked at a prior stage of replying to the connection number to the voice response unit, and then the response with the connection number is issued.

However, in the conventional telephone communication system, the database having the subscriber information registered, which is requisite for authenticating the subscriber, resides in the site of the service provider, and could not be used from the voice response unit. Accordingly, it is possible to receive the service so long as the connection number of the voice response unit is known even if the subscription to the service has not been made.

Particularly, when the connection number is a telephone number, the connection number can be readily known on the terminal screen because the calling number is displayed at the time of calling. Also, the service subscriber can inform the connection number to the service non-subscriber, or in the other situation, the service non-subscriber can get the connection number.

U.S. Pat. No. 5,945,989 discloses an IVR that is capable of accessing both a computer network and a telephone network and of modifying Webpages on the computer networks according to received commands via the telephone network. Further, this document discloses an application program having a content manager that performs user verification in order to allow only an authorized user to modify the Webpages.

U.S. Pat. No. 5,915,001 discloses a voice web system employing a voice response unit, for providing voice web services to a subscriber. In this document user verification using a unique account number that assigned to each subscriber is also disclosed.

EP-A-0 942 576 discloses a system allowing a user to access the Internet via voice telephone set. A special purpose platform receives a voice call from the subscriber and determines if the subscriber's telephone number received from a switch matches the associated with the subscriber by using a voice response unit (VRU) within the platform and a subscriber database.

These three documents disclose user verification for voice information services. However, in the systems disclosed in these documents, the users thereof directly call the voice response unit using a fixed number regardless of voice information that the user requires.

The present invention has been achieved in the light of the prior art, and it is an object of the invention to allow an IVR in a system in which a server and an IVR are independently accessible by telephone, equipment via different types of communication lines and a registered user of the system should be delivered by the server an access number corresponding to the IVR in which voice information desired by the user is previously stored, to authenticate a user.

### DESCLOSURE OF INVENTION

According to an embodiment of the present invention, there is provided a voice response unit which is connected to a computer network and which is used with a telephone communication system, comprising a voice database for storing the voice information, a user database for storing the information identifiable of the subscriber who can use the voice response unit, first interface means for effecting communication via a telephone line in response to a calling from a subscriber telephone terminal, authentication means for verifying whether or not the voice information can be provided to the subscriber telephone terminal of a caller, based on the user database, voice information providing means for providing the desired voice information to the subscriber telephone terminal that has been verified to be valid by the authentication means, second interface means which allows communication with the computer network, and database modifying means for changing the registered content of the user database in accordance with an instruction received via the second interface means.

According to another embodiment of the invention, there is provided a voice response unit for providing the voice information using a telephone line, comprising first interface means for effecting interface with the telephone line, second interface means for effecting interface with a computer network, a voice database for storing the voice information, a user database for storing the information identifiable of the subscriber who can use the voice response unit, and control means for controlling the response to a call from a subscriber telephone terminal, using the first interface means and the voice database, in accordance with a predetermined procedure, wherein the control means verifies whether or not the voice information can be provided to the subscriber telephone terminal of a caller, based on the user database, and only when it is determined that the voice information can be provided, the predetermined voice information is provided, and the content of the user database is changed in accordance with an instruction received via the second interface means.

According to another embodiment of the invention, there is provided a voice response unit which is connected to a computer network and which is used with a telephone communication system, comprising a voice database for storing the voice information, first interface means for effecting communication via a telephone line in response to a calling from a subscriber telephone terminal, second interface means for effecting communication with the computer network, authentication means for verifying whether or not the voice information can be provided to the subscriber telephone terminal of a caller, by referring via said second interface means to a user database which stores the information identifiable of the subscriber who can use said voice response unit, provided on said computer network, and voice information providing means for providing the desired voice information to the subscriber telephone terminal that has been verified to be valid by the authentication means.

According to another embodiment of the invention, there is provided a voice response unit for providing the voice information using a telephone line, comprising first interface means for effecting interface with the telephone line, second interface means for effecting interface with a computer network, a voice database for storing the voice information, and control means for controlling the response to a call from a subscriber telephone terminal, using the first interface means and the voice database, in accordance with a predetermined procedure, wherein the control means verifies whether or not the voice information can be provided to the subscriber telephone terminal of a caller, by referring via said second interface means to a user database which stores the information identifiable of the subscriber who can use the voice response unit, provided on the computer network, and only when it is determined that the voice information can be provided, the predetermined voice information is provided.

According to a further embodiment of the invention, there is provided a telephone communication system having a voice response unit of the invention.

According to a still further embodiment of the invention, there is provided a control method for a voice response unit which is connected to a computer network and which is used with a telephone communication system, the voice response unit comprising a voice database for storing the voice information, a user database for storing the information identifiable of the subscriber who can use the voice response unit, first interface means for effecting communication via a telephone line in response to a calling from a subscriber telephone terminal, and second interface means for effecting communication with the computer network, the method comprising an authentication step of verifying whether or not the voice information can be provided to the subscriber telephone terminal of a caller, based on the user database, a voice information providing step for providing the desired voice information to the subscriber telephone terminal that has been verified to be valid at the authentication step, and a database modifying means for changing the registered content of the user database in accordance with an instruction received via the second interface means.

According to another embodiment of the invention, there is provided a control method for a voice response unit for providing the voice information using a telephone line, the voice response unit comprising first interface means for effecting interface with a telephone line, second interface means for effecting interface with a computer network, a voice database for storing the voice information, a user database for storing the information identifiable of the subscriber who can use the voice response unit, the method comprising a control step for controlling the response to a calling from a subscriber telephone terminal, using the first interface means and the voice database, in accordance with a predetermined procedure, wherein the control step verifies whether or not the voice information can be provided to the subscriber telephone terminal of a caller, based on the user database, and only when it is determined that the voice information can be provided, the predetermined voice information is provided, and the content of the user database is changed in accordance with an instruction received via the second interface means.

According to another embodiment of the invention, there is provided a control method for a voice response unit which is connected to a computer network and which is used with a telephone communication system, the voice response unit comprising a voice database for storing the voice information, first interface means for effecting communication with a telephone line, in response to a call from a subscriber telephone terminal, second interface means for effecting communication with the computer network, the method comprising an authentication step for verifying whether or not the voice information can be provided to the subscriber telephone terminal of a caller, by referring via said second interface means to a user database for storing the information identifiable of the subscriber who can use the voice response unit, provided on the computer network, and a voice information providing step for providing the desired voice information to the subscriber telephone terminal which has been verified to be valid at the authentication step.

According to another embodiment of the invention, there is provided a control method for a voice response unit for providing the voice information using a telephone line, the voice response unit comprising first interface means for effecting interface with the telephone line, second interface means for effecting interface with a computer network, a voice database for storing the voice information, the control method comprising a control step for controlling the response to a call from a subscriber telephone terminal using the first interface means and the voice database, in accordance with a predetermined procedure, wherein the control step verifies whether or not the voice information can be provided to the subscriber telephone terminal of a caller, by referring via said second interface means to a user database which stores the information identifiable of the subscriber who can use the voice response unit, provided on the computer network, and only when it is determined that the voice information can be provided, the predetermined voice information is provided.

### BRIEF DESCRIPTION OF DRAWINGS

FIG. 1 is a block diagram for explaining an overall configuration example of a mobile radio communication system using a voice response unit according to an embodiment of the present invention;

FIG. 2 is a block diagram showing a configuration example of a voice response unit according to the embodiment of the invention;

FIG. 3 is a flowchart for explaining the operation of an information-providing site in the system of FIG. 1;

FIGS. 4A and 4B are data format examples of a user DB update instruction for use in the system of FIG. 1;

FIG. 5 is a flowchart for explaining a user DB update processing for the voice response unit or the information-providing site which has received the user DB update instruction of FIG. 4A or 4B; and

FIG. 6 is a flowchart for explaining an operation of the voice response unit according to the embodiment of the invention.

### BEST MODE FOR CARRYING OUT THE INVENTION

First Embodiment

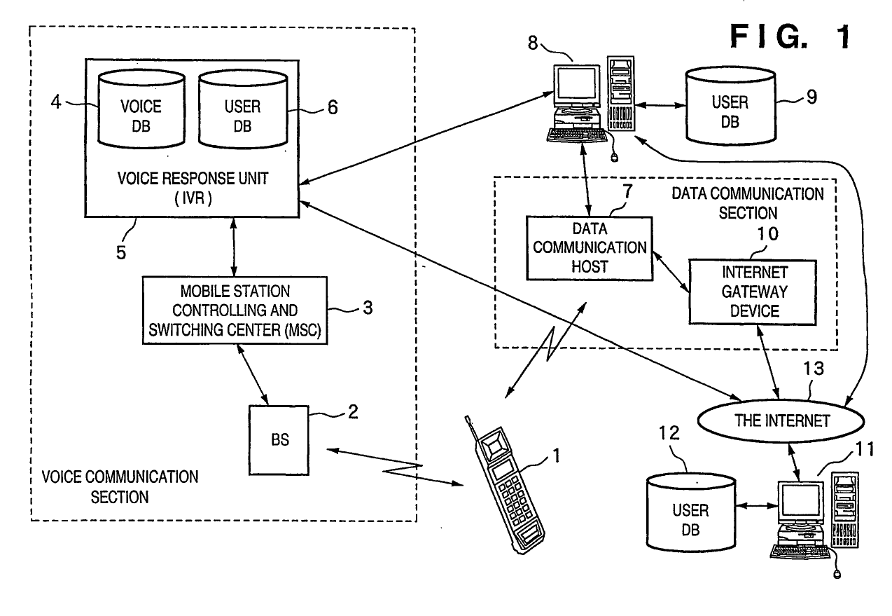

A First Embodiment of the present invention will be described below in detail with reference to the drawings. FIG. 1 is a block diagram illustrating an overall configuration of a mobile radio communication system as one example of a telephone communication system using a voice response unit according to one embodiment of the present invention.

The mobile radio communication system of FIG. 1 consists of an voice communication section for performing an ordinary voice communication service, and a data communication section for providing a data communication service by the use of a packet data transmission or the like.

The voice communication section has a mobile radio communication terminal 1 which is a mobile station, a base station 2, a mobile station controlling and switching center (MSC) 3 for controlling the connection between mobile radio communication terminals, and a voice response unit (IVR) 5. Also, the voice response unit 5 has internally a voice database (DB) 4 and a user database (DB) 6.

The data communication section has a data communication host 7 and an Internet gateway device 10 for connecting the mobile radio communication system to the Internet 13. Also, the information-providing sites 8, 11 are a so-called HTTP server which performs a service of providing the information to the subscriber via the data communication host 7, and have user databases 9 and 12 for registering the service subscribers, respectively. Such information-providing sites can be implemented using a general-purpose computer having a network I/F such as an Ethernet interface. And the communication between the data communication host 7 and the information-providing sites 8, 11 can be made in accordance with a general-purpose communication protocol such as TCP/IP.

In the drawing, an information-providing site 8 represents a site connected directly to the data communication host 7, and an information-providing site 11 represents a site which resides on the Internet. The information-providing site 11 on the Internet is connected to the data communication host 7 via the internet gateway device 10 which connects the Internet 13 and mobile radio communication system.

The voice response unit 5 in the voice communication section and the information-providing sites 8, 11 in the data communication section are connected so that they can communicate the data. This connection may be directly made, but may be made via a network such as the Internet 13. The communication between the voice response unit 5 and the information-providing sites 8, 11 can be performed in accordance with a general-purpose communication protocol such as TCP/IP.

In FIG. 1, the mobile radio communication terminal 1, the base station 2, MSC 3, the information-providing sites 8 and 11 are shown singly for the easy understanding, but practically each of them exists in plurality. Also, a plurality of voice response unites 5 may exist.

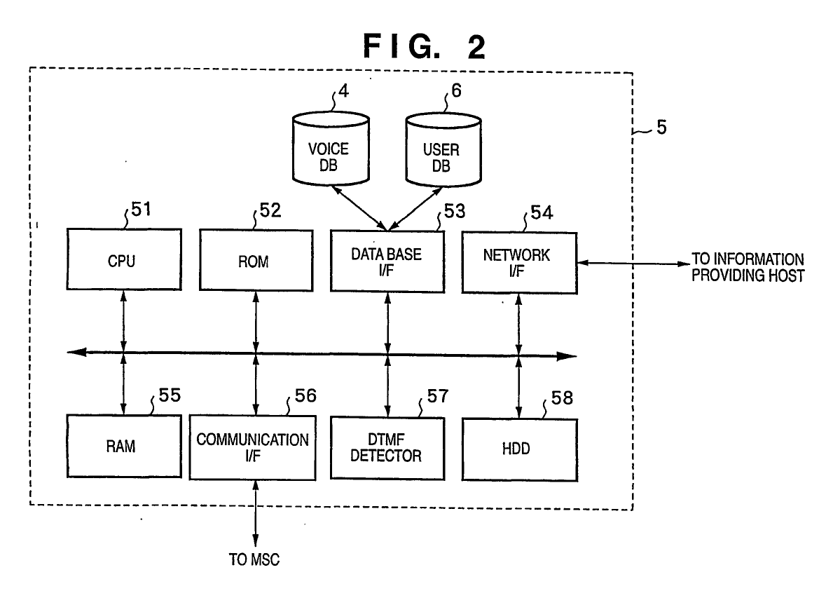

FIG. 2 is a block diagram illustrating a configuration example of the voice response unit 5 according to this embodiment. The voice response unit 5 comprises a CPU 51 for controlling the whole apparatus, a ROM 52 for storing the programs which the CPU 51 executes or various data, a database I/F 53 which is an interface with a voice DB 4 and a user DB 6, a network I/F 54 which is an interface for effecting data communication with the information providing hosts 8, 11, a RAM 55 for use as a work area for the CPU 51, a communication I/F 56 for effecting voice communication with the subscriber via the MSC 3, a DTMF detector 57 for detecting a key which has been depressed at a subscriber terminal, and an HDD 58 for storing a voice response application and the programs executed by the CPU 51. Also, the components excluding the voice DB 4 and the user DB 6 are interconnected via the buses of the CPU 51 (data bus, address bus and control bus).

The voice response unit 5 can be implemented using a general-purpose computer having a network I/F such as Ethernet interface, and a communication interface such as NCU (or modem) or the like. Also, to digitize and/or encode/decode a voice signal, a dedicated hardware may be provided, without the CPU 51 executing any program for such processing.

In this way, the voice response unit 5 according to this embodiment may take any configuration so long as it serves as a telephone set equivalent to a subscriber's terminal in the voice communication section and a data communicable terminal for the information-providing sites 8, 11.

In such a system, when the user (subscriber of the mobile radio communication terminal 1) wants to accept an information providing service for the registered member, the user first connects the system to an information-providing site that provides a desired service and makes a subscription procedure to the service.

For example, if the user depresses a connection button provided at the mobile radio communication terminal 1 to make connection with the data communication host 7, the data communication host 7 checks whether or not data communication service is available to the mobile radio communication terminal 1 (i.e., the mobile radio communication terminal 1 is a terminal capable of data communication and/or the user is a subscriber to the data communication service).

When the subscriber meets all the conditions for data communication service, the data communication host 7 sends data for displaying an initial menu to the mobile radio communication terminal 1. And a control unit not shown within the mobile radio communication terminal 1 displays the initial menu on a display device such as LCD, based on the received data.

The user selects necessary items from this menu hierarchically to search for a desired information-providing site, or inputs an address of the information-providing site (URL or IP address) without using the menu to effect data communication with the information-providing site.

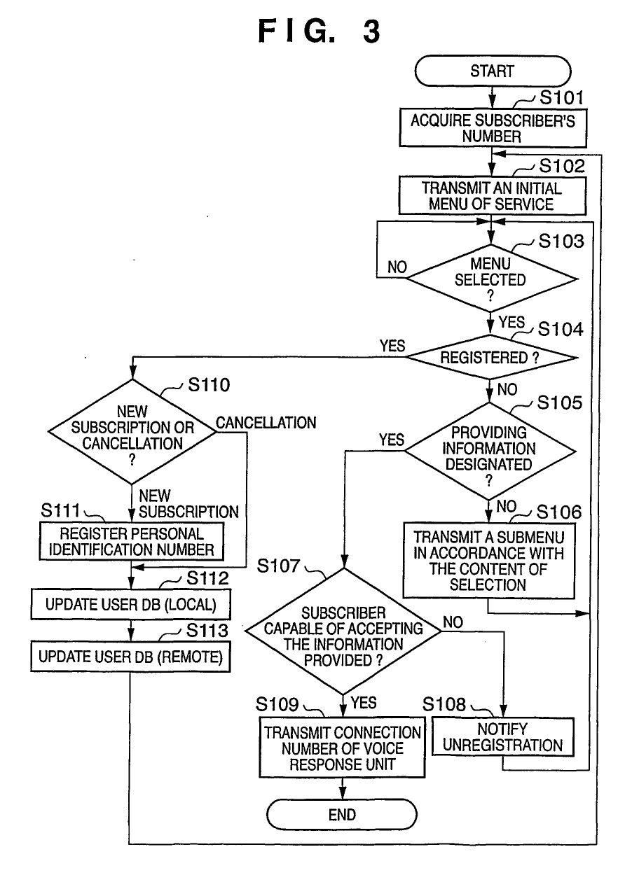

Next, explanation will be given of a processing in the information-providing site at the time of providing the service, using a flowchart as shown in FIG. 3. In the following explanation, the information desired by the user resides in the information-providing site 8 as a matter of convenience. However, the same processing can be performed when there is an access request to the information-providing site 11.

Firstly, a subscriber's number (telephone number) of a subscriber's terminal which requests the access is acquired (step S101). The data for displaying an initial menu screen in the information-providing site is transmitted to the subscriber's terminal (step S102). The data for displaying the menu screen may be in any of the formats which can be interpreted by an application program at the terminal. However, a general-purpose markup language such as an HTML (SGML, XML) or its extended versions, or WAP, etc., may be used.

From the initial menu displayed on a terminal screen, the process waits for the user to select a menu item (step S103). If a selection is detected, the selected item is determined (step S104). As a result of determination, if the selection involves a processing requiring changing the content of the user DB, such as a new subscription or a cancellation of registration (registration process), the process proceeds to step S100. Otherwise, the process proceeds to step S105 to check the final selection of items, i.e., whether or not the information desired by the user has been designated.

At a determination at step S105, if the selected item involves an instruction of displaying a submenu but not designating the information, the data for displaying the submenu of the selected item is transmitted, and the process returns to step S103. On the other hand, if it is determined at step S105 that the information desired by the user has been designated, the process proceeds to step S107.

At step S107, it is checked whether or not the subscriber's number acquired at step S101 is registered in the user DB 9. If not registered, a message that registration is necessary to provide the information desired by the user is transmitted to the subscriber's terminal (step S108), and the process returns to step S103.

Herein, the display data (e.g., a message “A new registration here?”) having the link to a new registration screen as will be described later may be transmitted, along with the display of the message, and even if the user does not select items from the initial menu again, the process may transfer directly to the registration process.

On the other hand, if it is confirmed that the subscriber has been registered at step S107, the process proceeds to step S109, where a connection number for the voice response unit 5 is transmitted. As described above, the connection number can be transmitted as the screen display data, or in the form of an electronic mail in which the connection number is contained in a text.

In either case, the user who has received the connection number can select a connection number on the screen, or manually enter the number displayed on the screen, and can make a call. Then, the subscriber's terminal is connected to the voice response unit 5. By depressing a terminal key in accordance with a voice guidance replied from the voice response unit 5, the user can listen to the desired information. Of course, the system may be configured in the other way that, if the connection number itself contains for specifying the information designated at step S105, a connection may automatically occur to the voice response unit 5, to allow the user to listen to the designated information.

On the other hand, if it is checked that a processing (registration process) requiring changing the content of the user DB, such as a new subscription or a cancellation of registration, is selected at step S104, an update processing of the database is necessary.

At step S110, whether the processing is a new subscription or a cancellation is determined. In the case of the new subscription, the display data of a personal identification number registration screen is transmitted, and a personal identification number returned from the terminal is once stored (step S111).

And at step S112, the user DB 9 which is a local user DB for the information-providing host 8 is updated. The local user DB 9 is updated by creating a new record having at least in a field the subscriber's number acquired at step S101 and the personal identification number set up at step S111 in the case of new registration. On the other hand, in the case of cancellation (deletion), a registered record of the user DB 6 is retrieved using the subscriber's number acquired at step S101, and the corresponding record is deleted.

If the updating of the local user DB 9 has been ended, the user DBs 6 and 12 which are remote user DBs are updated (step S113). The updating of the remote user DB is performed in such a way as to transmit an update instruction of database from the information-providing site 8 to the voice response unit 5 and the information-providing site 11 to which the remote user DBs are connected, and to interpret and execute this update instruction on the receiver side.

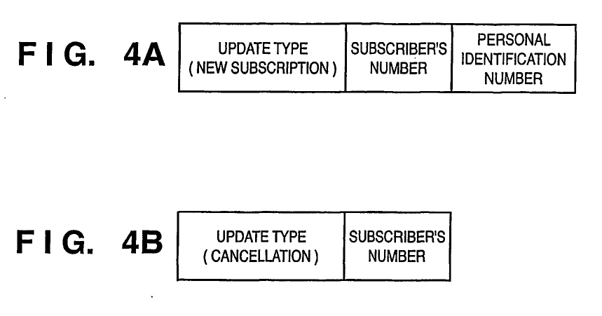

FIGS. 4A and 4B show examples of data format of a database update instruction. FIG. 4A shows a data format when the new registration is made, and FIG. 4B shows a data format when the cancellation is made. That is, the database update instruction having an update type is stored in the first field. And in case of new registration, a subscriber's number is stored in the second field and a personal identification number is stored in the third field. In case of cancellation (deletion), it has the subscriber's number in the second field.

Since this database update instruction is transmitted in accordance with the TCP/IP, as described above, other data such as a header may be added at the time of actual transmission. The strict format is not directly related to the invention, and is not described here. In essence, the transmission is effected in the format of and in accordance with a protocol of the data which the voice response unit 5 and the information-providing site 11 (or information-providing site 8) can receive or interpret and execute.

If the updating of the all remote user DBs has been completed, the contents of the user DBs are synchronized with each other, so that the voice response unit 5, and the information-providing sites 8 and 11 can authenticate the user, based on a common user DB.

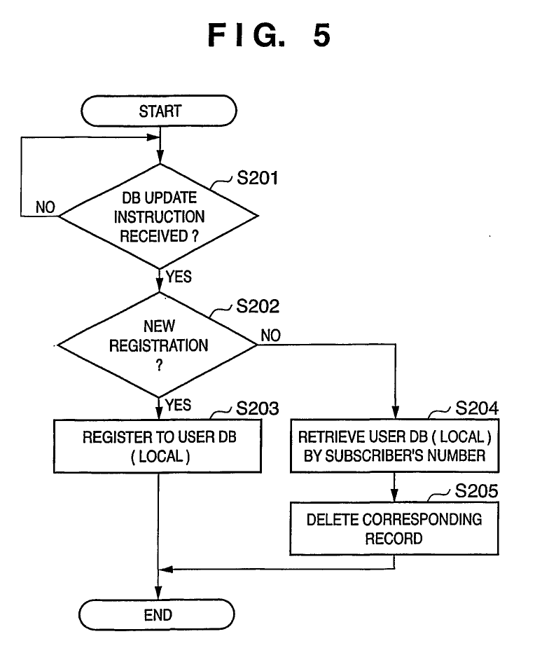

FIG. 5 is a flowchart showing the processing of the voice response unit 5 (or information-providing site 11) which has received a database update instruction as shown in FIG. 4A or 4B. First, it is checked whether or not a database update instruction has been received via the network I/F 54 (step S201).

When the reception is detected, it is checked whether or not the content of the first field indicating the update type is a new registration (step S202). In the case of new registration, at step S203, a record containing the subscriber's number and the personal identification number stored in the second and third fields of the database update instruction is newly created in the user DB 6 that is the local user DB (step S203).

In case of cancellation, the user DB 6 is retrieved by the subscriber's number stored in the second field of the database update instruction (step S204), and the corresponding record is deleted (step S205).

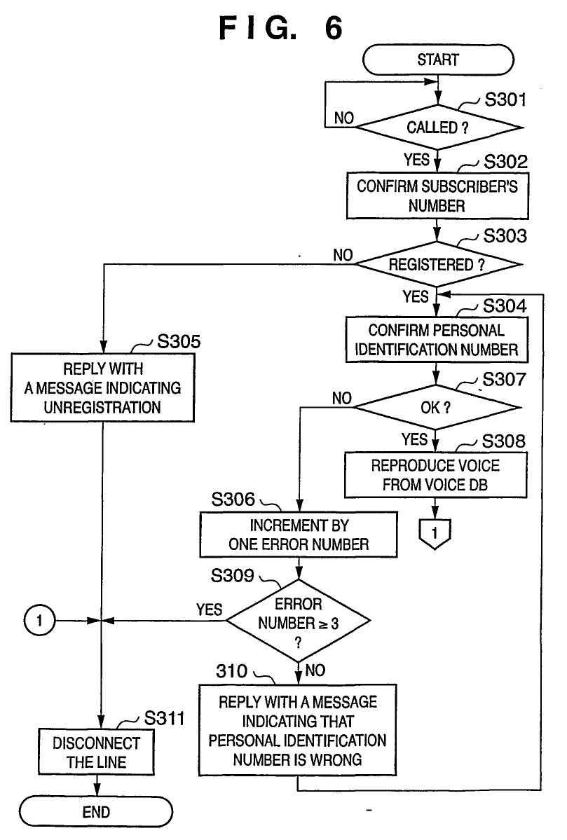

Next, explanation will be given of a voice response processing in the voice response unit 5, with reference to FIG. 2 showing the configuration of the voice response unit 5 and using a flowchart as shown in FIG. 6.

As described above, in this embodiment, the voice response unit 5 acts as a telephone set in the voice service section, whereby the connection number for use in connecting the mobile radio communication terminal device 1 to the voice response unit 5 is a telephone number assigned to the voice response unit 5.

Accordingly, if a call is made to a connection number transmitted from the information-providing site, the connection number is transmitted via the base station (BS) 2 in charge of the mobile radio communication terminal 1 to the MSC 3, like the ordinary service, so that the MSC 3 can identify a connection destination, i.e., a location of the voice response unit 5, by referring to the HLR (Home Location Register), not shown.

In this case, since the voice response unit 5 is connected directly to the MSC 3, the MSC 3 calls the voice response unit 5. If the voice response unit 5 replies, the connection between the mobile radio communication terminal 1 and the voice response unit 5 is established.

FIG. 6 is a flowchart showing a processing from a state where the voice response unit 5 is waiting for a call. As described above, the following processing is effected by the CPU 51, which executes a program stored in the ROM 52 and/or HDD 58 to control each block of the voice response unit 5.

First, it is checked whether or not there is a call from the MSC 3 in the communication interface 56 (step S301). If the call is detected, the subscriber's number of a caller is acquired by making off-hook and connecting to the line (step S302). The subscriber's number acquired is once stored in the RAM 55.

At step S303, the user DB 6 is retrieved via the database I/F 53, using the subscriber's number stored in the RAM 55, and it is checked whether or not the subscriber of the caller is one capable of receiving the information providing service, i.e., the subscriber's number is registered in the user DB 6.

Herein, in the case where the subscriber's number of the caller is not registered in the user DB 6, a message indicating the unregistration that “This service requires a registration in advance. The registration destination is http// . . . ” is read out from the voice DB 4 and reproduced (step S305).

The voice data stored in the voice DB 4 may or may not be compressed encoded, so long as it can be reproduced by a reproducing application which the CPU 51 can execute. And the compressed encoding may be in any form. The format of voice data may be determined at will in consideration of the content of voice information to be stored, the quality of communication line, the load on the CPU 51, and the data capacity.

If the message indicating unregistration has been reproduced, the line is forcibly disconnected (step S311), and the processing is ended.

On the other hand, in the case where the calling subscriber is registered in the user DB 6, the corresponding personal identification number is read out, and stored in the RAM 55. And a voice message of “Input your personal identification number. Then press the # key.” is read out from the voice DB 4 and reproduced. Then the process waits for a reply from the user.

The user enters a personal identification number set up at the time of registration and presses the # key from the ten key of the mobile radio communication terminal 1, in response to a voice message. Then these input values are detected by the DTMF detector 57, and a result of determination is once stored in the RAM 55. And a comparison is made between the personal identification number which is registered in the user DB 6 and read out in advance and the input personal identification number of the calling subscriber (step S304).

As a result of comparison, it is checked whether or not both the personal identification numbers are matched (step S307). If they are matched, the voice information provided from the voice DB 4 is read out and reproduced (step S308). And if the user disconnects the line halfway, or the reproducing of voice data is ended, the line is disconnected (step S311). The processing is ended.

Of course, at the time when the reproducing of voice data is ended, an inquiry may be made as to whether or not the repetitive reproducing is desired. If the repetitive reproducing is instructed, the voice information is reproduced again. If not, the line is disconnected.

On the other hand, if the personal identification numbers are unmatched at step S307, an error number counter, which is for example in a predetermined area of the RAM 55, is incremented by one (step S306). And it is checked whether or not the error number counter reaches a predetermined value, or 3 in this case (step S309). If it is less than 3, a message indicating that the personal identification number is wrong, e.g., a voice message of “The personal identification number is wrong. Enter a correct number again.” is read out from the voice DB 4 and reproduced. Then the process proceeds to step S304.

In the case when an erroneous personal identification number is entered three times consecutively, the process transfers from step S309 to step S311, because the error number counter has reached three. The line is forcibly disconnected and the processing is ended. That is, in this embodiment, if the personal identification number is mistaken three times consecutively, it is determined that the caller is not a valid subscriber. Therefore, the processing is aborted.

In this way, the registration information at the time of subscription can be also referred in the voice response unit. Particularly in the mobile radio communication system which is comprised of a voice communication section and a data communication section, only the valid subscriber can be authenticated to accept the voice information.

In the above embodiment, the personal identification number is registered at the time of new registration. However, the caller may be authenticated simply based on the subscriber's number, without using the personal identification number.

The updating method of the user DB may be any of other methods.

That is, the essence of the present invention is to provide a database for use in effecting the authentication by referring to the information which can not be controlled by the subscriber and is unique to the subscriber (or subscriber terminal), so that the voice response unit can make use of the database. The content of the information to be registered in this database or the authenticating method itself can be selected at will.

In the above embodiment, the connection number of the voice response unit 5 corresponds one-to-one to the voice information desired by the user. However, the connection number may not correspond to the voice information one-to-one, and after connecting to the voice response unit 5, various selections may be made in accordance with a voice message to get ultimately the voice information.

More specifically, the thing designated at step S105 in FIG. 3 is not the information itself, but a title or the like containing a lot of voice information such as “Schedule for this week” and “New songs for this week.” After connecting to the voice response unit 5, it is possible to make a selection in such a way as to “What day of the week do you want the schedule for? Enter 1 for Monday, 2 for Tuesday, . . . ” or “Enter 1 for A music of the X band, 2 for B music of the Y band . . . . ” Of course, the items to be selected in the voice response unit 5 may be layered hierarchically.

In the above embodiment, the information-providing sites 8 and 11 provide different information providing services, and both the services can be acquired at one time of registration. However, in the case where the service requiring a registration for each information-providing site is provided, the user DB 6 connected to the voice response unit 5 may be divided into a region corresponding to the user DB 9 and a region corresponding to the user DB 12, which are independently synchronized with the user DB.

In this case, the voice response unit 5 can discriminate which region is updated in accordance with a sender address of the DB update instruction.

Additionally, in the case where the user can make registration at any one of a plurality of information-providing sites to accept any service provided by the plurality of information-providing sites, a registration information server for managing the registered information collectively may be provided to share the user DBs of the information-providing sites. By sharing the user DBs of the information-providing sites, a synchronization process between the individual user DBs is unnecessary. Further, if the registered information server is accessible from the voice response unit 5, the updating of the database may be instructed to the registration information server, and the synchronization process of the user DBs is not necessary at all.

A way of arranging or sharing the user DBs can be set up or changed at will in accordance with the type of information to be provided, the number of accesses from the user, and the kind of accounting.

Further, in the above embodiment, the mobile radio communication system was exemplified as the telephone communication system. However, it is needless to say that the mobile radio communication system may be a telephone communication system using a fixed telephone so long as the voice response unit is connected to the telephone line, and the management of services by the use of the voice response unit is performed by the information processing apparatus on the computer network.

As described above, with the present invention, in the voice response unit for use with the mobile radio communication system, the user who can accept the service through the use of this voice response unit can be identified correctly.

1. An information providing system for providing predetermined information to registered subscriber terminals, said system including a user database (6,9,12) for storing subscriber information relating to said registered subscriber terminals, said system characterized in that comprising:
a server (8,11), accessible by said subscriber terminals (1) via a packet communication network, for determining if a subscriber terminal is one of said registered subscriber terminals by using said user database when an information request from said subscriber terminal is received, and if said subscriber terminal is one of said registered subscriber terminals and said information request requests for voice information, informing an access number of a voice response unit in which said requested voice information is stored; and
a voice response unit (5), accessible by said subscriber terminals via a telephone network, for determining if a subscriber terminal is one of said registered subscriber terminals by using said user database when an access number assigned to said voile response unit is called by said subscriber terminal, and if said subscriber terminal is one of said registered subscriber terminals, providing said voice information requested by said subscriber terminal thereto.

2. The system according to claim 1, characterized in that said server (8,11) registers or updates said subscriber information, in response to a registration or update request from a subscriber terminal, based on received information from said subscriber terminal (1).

3. The system according to claim 1, characterized in that said user database (6,9,12) comprises a first database (9,12) accessible with said server (8,11) and a second database (6) accessible with said voice response unit (5), and the system further comprises a synchronizing means (5,8,11) for synchronizing said second database (6) with said first database (9,12).

4. The system according to claim 3, characterized in that said first database (9,12) is locally connected to or included in said server (8,11); and
said second database (6) is locally connected to or included in said voice response unit (5).

5. The system according to claim 3, characterized in that said synchronizing means is a part of said server (8, 11) and voice response unit (5).

6. The system according to claim 1, characterized in that said user database (6,9,12) comprises a first database (9,12) accessible with said server (8,11), and a second database (6) accessible with said voice response unit (5), and said server further provides a command to synchronize the contents of said first and second databases to said voice response unit via a communication line therebetween.

7. The system according to claim 6, characterized in that said voice response unit (5) updates said second database (6) in response to said command received from said server (8,11).

8. The system according to any one of claims 1 to 7, characterized in that said server or voice response unit determines if said subscriber terminal is one of said registered subscriber terminals based on a subscriber number of said subscriber terminal.

9. The system according to any one of claims 1 to 7, characterized in that said server or voice response unit determines if said subscriber terminal is one of said registered subscriber terminals based on a subscriber number of said subscriber terminal and a personal identification number sent therefrom.

10. A control method for controlling an information providing system for providing predetermined information to registered subscriber terminals, said system including a server, accessible by said subscriber terminals via a packet communication network, a user database for storing subscriber information relating to said registered subscriber terminals, and a voice response unit, accessible by said subscriber terminals via a telephone network, said method characterized in that comprising:
a server controlling step of controlling said server to determine if a subscriber terminal is one of said registered subscriber terminals by using said user database when an information request from said subscriber terminal is received, and if said subscriber terminal is one of said registered subscriber terminals and said information request requests for voice information, to inform an access number of a voice response unit in which said requested voice information is stored, and
a voice response unit controlling step of controlling said voice response unit determine if a subscriber terminal is one of said registered subscriber terminals by using said user database when an access number assigned to said voice response unit is called by said subscriber terminal, and if said subscriber terminal is one of said registered subscriber terminals, to provide said voice information requested by said subscriber terminal thereto.

11. The method according to claim 10, characterized in that said server controlling step further controls said server to register or update said subscriber information, in response to a registration or update request from a subscriber terminal, based on received information from said subscriber terminal.

12. The method according to claim 10, characterized in that said user database comprises a first database accessible with said server and a second database accessible with said voice response unit, and the method further comprises a synchronizing step of synchronizing said second database with said first database.

13. The method according to claim 12, characterized in that said first database is locally connected to or included in said server, and said second database is locally connected to or included in said voice response unit.

14. The method according to claim 12, characterized in that said synchronizing step is a part of said server controlling step and said voice response unit controlling step.

15. The method according to claim 10, characterized in that said user database comprises a first database accessible with said server and a second database accessible with said voice response unit, and said server controlling step further controls said server to provide a command to synchronize the contents of said first and second databases to said voice response unit via a communication line therebetween.

16. The method according to claim 15, characterized in that said voice response unit controlling step further controls said voice response unit to update said second database in response to said command received from said server.

17. The method according to any one of claims 10 to 16, characterized in that said server or voice response unit controlling step controls said server or voice response unit to determine if said subscriber terminal is one of said registered subscriber terminals based on a subscriber number of said subscriber terminal.

18. The method according to any one of claims 10 to 16, characterized in that said server or voice response unit controlling step controls said server or voice response unit to determine if said subscriber terminal is one of said registered subscriber terminals based on a subscriber number of said subscriber terminal and a personal identification number sent therefrom.
